(19) United States
(12) Patent Application Publication
(10) Pub. No.: US 2014/0133085 A1
(43) Pub. Date: May 15, 2014

(54) MEMORY COMBINATION AND COMPUTER SYSTEM USING THE SAME

(71) Applicants: INVENTEC (PUDONG) TECHNOLOGY CORPORATION, (US); INVENTEC CORPORATION, Taipei City (TW)

(72) Inventors: Yen-Cheng Lin, Taipei City (TW); Ming-Hung Shih, Taipei City (TW); Hsin-Liang Chen, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 13/785,578

(22) Filed: Mar. 5, 2013

(30) Foreign Application Priority Data
Nov. 12, 2012 (CN) 201210449151.6

(51) Int. Cl. G06F 1/18

(52) U.S. Cl. CPC G06F 1/185
USPC 361/679.32

(57) ABSTRACT

A memory combination is applied in a computer system. The computer system includes a motherboard. The motherboard includes a first riser slot and a second riser slot disposed side by side. The memory combination includes a first riser board and a second riser board. The first riser board is plugged into the first riser slot and includes a plurality of first memory sockets. The second riser board is plugged into the second riser slot and includes a plurality of second memory sockets. The first memory sockets face the second riser board, and the second memory sockets face the first riser board. The first memory sockets are unaligned with the second memory sockets.

### RELATED APPLICATIONS

This application claims priority to China Application Serial Number 201210449151.6, filed Nov. 12, 2012, which is herein incorporated by reference.

### BACKGROUND

1. Field of Invention

The invention relates to a memory combination and a computer system using the same.

2. Description of Related Art

In existing computer systems, most of the memory modules, such as Dual In-line Memory Modules (DIMMs), are directly plugged into memory sockets of a motherboard. However, in order to use more memory modules in a server, a riser board is used to increase the number of the memory modules. In all of the current approaches, a plurality of memory modules are plugged into a single riser board to form one memory combination. Then, the whole memory combination is plugged into a riser slot on the motherboard. A control chip is disposed on the riser board for controlling reading data from and writing data to the various memory modules on the riser board.

Referring to FIG. 4, a side view of a conventional riser board 54 plugged into a motherboard 12 is illustrated. From FIG. 4, it can be seen that present day techniques for plugging a plurality of riser boards 54 into the motherboard 12 orient memory modules 18 on each riser board 54 towards the same direction and enable the riser boards 54 to be arranged closely. Nonetheless, it is inevitable that a control chip 542 disposed on the riser board 54 occupies a portion of space on the riser board 54, and memory sockets 540 cannot be disposed in the occupied space. Accordingly, this leads to the space between the two riser boards 54 corresponding to the control chip 542 being unused, and ineffectively employed. Therefore, in the case that the height and space of the server are limited, how to place more memory modules 18 in the limited space is a challenge to those in the art.

### SUMMARY

The invention provides a memory combination applied in a computer system. The computer system includes a motherboard. The motherboard includes a first riser slot and a second riser slot disposed side by side. The memory combination includes a first riser board and a second riser board. The first riser board is plugged into the first riser slot and includes a plurality of first memory sockets. The second riser board is plugged into the second riser slot and includes a plurality of second memory sockets. The first memory sockets face the second riser board, and the second memory sockets face the first riser board. The first memory sockets are unaligned with the second memory sockets.

In an embodiment of the invention, the above-mentioned first memory sockets are arranged closely to form a first memory socket group. The second memory sockets are arranged closely to form a second memory socket group. The first memory socket group is unaligned with the second memory socket group.

In an embodiment of the invention, the above-mentioned first riser board further includes a first control chip. The first control chip is electrically connected to the first memory sockets. The first memory sockets and the first control chip are located on a first region and a second region of the first riser board respectively. The second riser board further includes a second control chip. The second control chip is electrically connected to the second memory sockets. The second memory sockets and the second control chip are located on a third region and a fourth region of the second riser board respectively. The first region is aligned with the fourth region and the second region is aligned with the third region.

In an embodiment of the invention, the above-mentioned first and second memory sockets are unaligned with each other by an alternated and staggered arrangement manner.

In an embodiment of the invention, a gap between any two adjacent ones of the above-mentioned first memory sockets is aligned with one of the second memory sockets, and a gap between any two adjacent ones of the second memory sockets is aligned with one of the first memory sockets.

The invention further provides a computer system including a motherboard, a first riser board and a second riser board. The motherboard includes a first riser slot and a second riser slot disposed side by side. The first riser board is plugged into the first riser slot and includes a plurality of first memory sockets. The second riser board is plugged into the second riser slot and includes a plurality of second memory sockets. The first memory sockets face the second riser board, and the second memory sockets face the first riser board. The first memory sockets are unaligned with the second memory sockets.

In view of the above, an essential feature of the present invention is that when the two riser boards are plugged into the motherboard, the memory sockets on the two riser boards are disposed in an opposite direction and are unaligned with each other. Accordingly, when all the memory sockets are filled full of memory modules, the memory modules between the two riser boards are unaligned with each other and arranged more closely so as to use the space between the two riser boards effectively. Additionally, another essential feature of the present invention is that the memory sockets on any one of the two riser boards are unaligned with the memory sockets on the other riser board in the form of groups and are aligned with the position of the control chip on the other riser board. Accordingly, the space between the two riser boards corresponding to two control chips is not unused so as to improve the space usage of the memory combination more effectively.

### BRIEF DESCRIPTION OF THE DRAWINGS

FIG. 1 is a perspective view illustrating a computer system according to an embodiment of the invention;

FIG. 2A is a perspective view illustrating a memory combination plugged into the motherboard in the computer system in FIG. 1 according to an embodiment of the invention;

FIG. 2B is another perspective view illustrating the memory combination plugged into the motherboard in FIG. 2A;

FIG. 2C is a side view illustrating the memory combination and the motherboard in FIG. 2A;

FIG. 3A is a perspective view illustrating a memory combination plugged into the motherboard in the computer system in FIG. 1 according to another embodiment of the invention;

FIG. 3B is another perspective view illustrating the memory combination plugged into the motherboard in FIG. 3A;

FIG. 3C is a side view illustrating the memory combination and the motherboard in FIG. 3A; and

FIG. 4 is a side view illustrating a conventional riser board plugged into the motherboard.

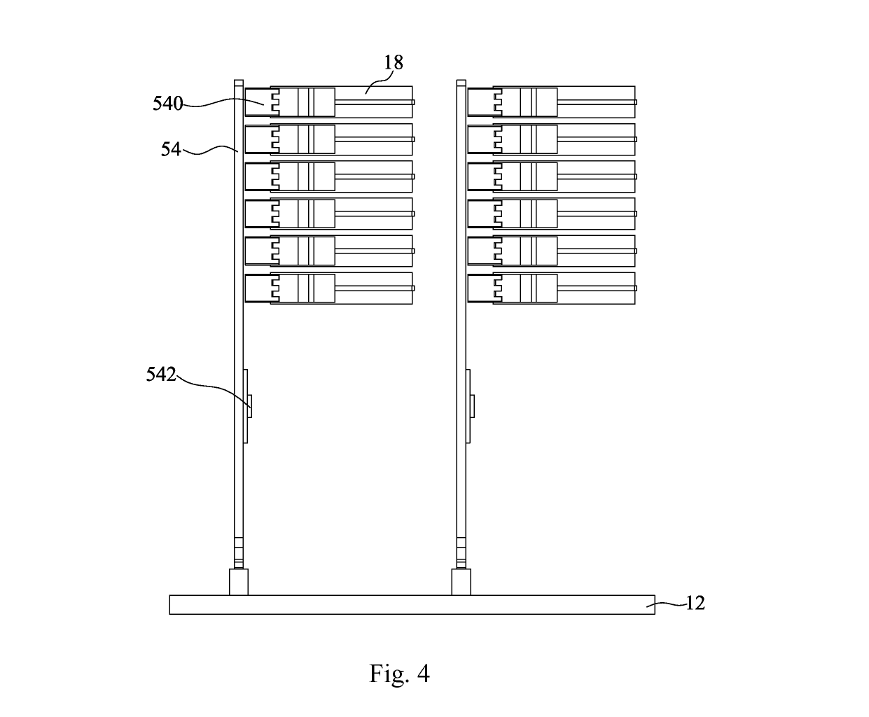

### DETAILED DESCRIPTION

A plurality of embodiments of the invention will be disclosed hereafter with reference to drawings. For purposes of clear illustration, many details in practice will be described together in the following disclosure. However, it should be understood that these details in practice are not intended to limit the invention. That is, for some embodiments of the invention, these details in practice are unnecessary. Additionally, for purposes of simplifying drawings, some conventional structures and elements in the drawings will be illustrated schematically.

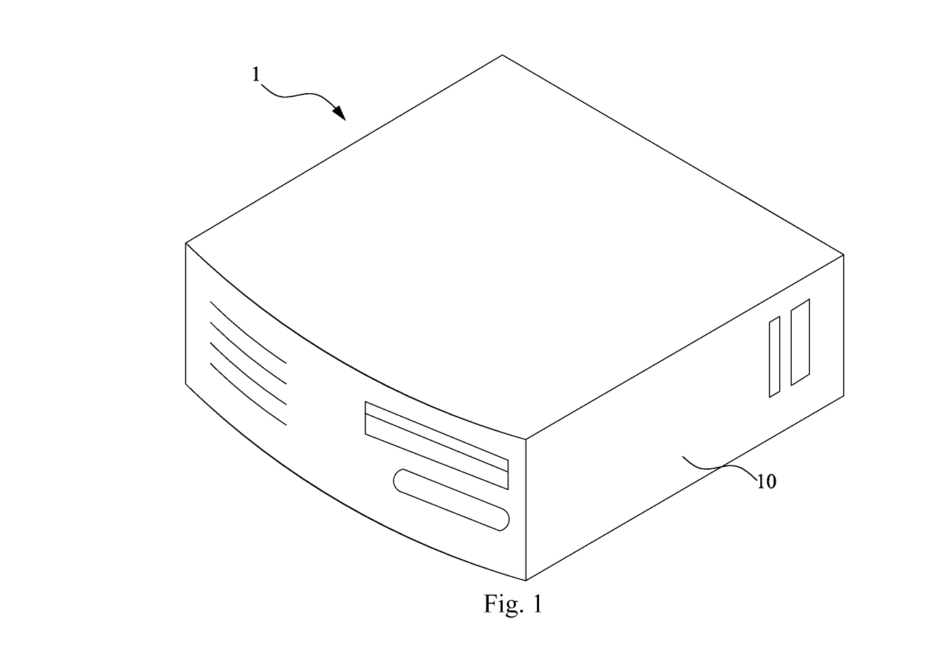

FIG. 1 illustrates a perspective view of a computer system 1 according to an embodiment of the invention.

In FIG. 1, the computer system 1 of this embodiment is exemplified as a server, although the invention is not limited to such. For any computer system 1, as long as it is required to plug many memory modules into the motherboard in the computer system 1, the concept of the memory combination of the invention can be applied to improve the space utilization in a housing 10 of the computer system 1 effectively.

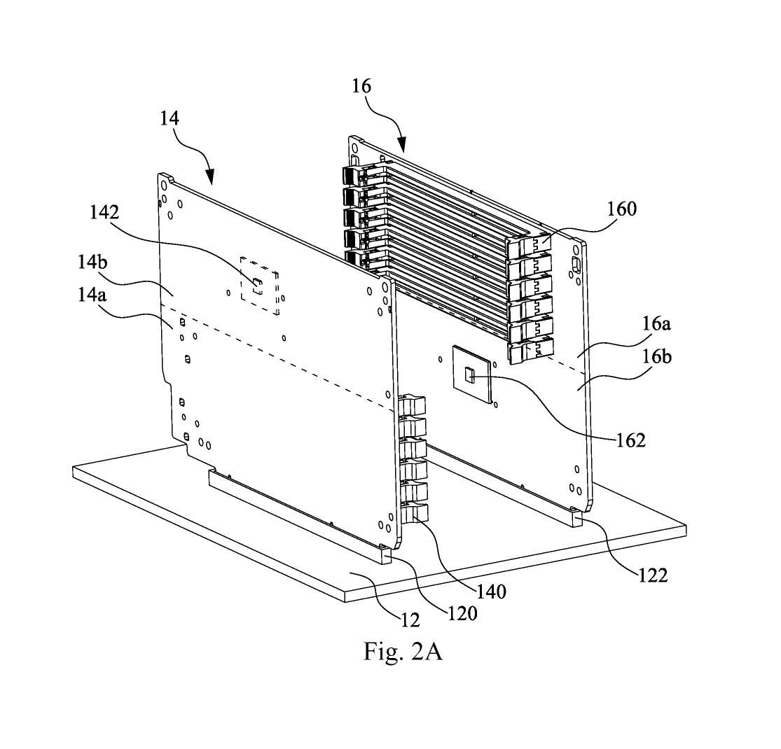

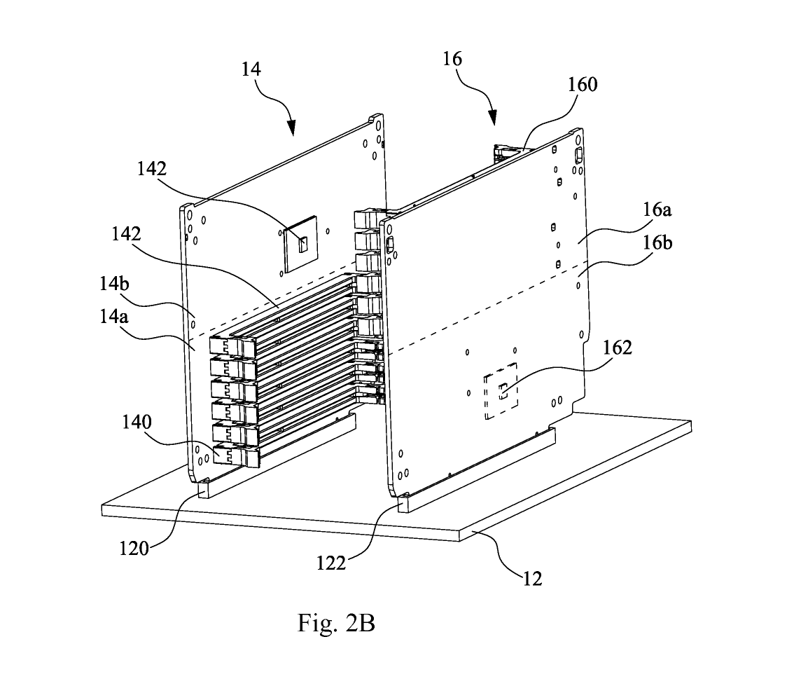

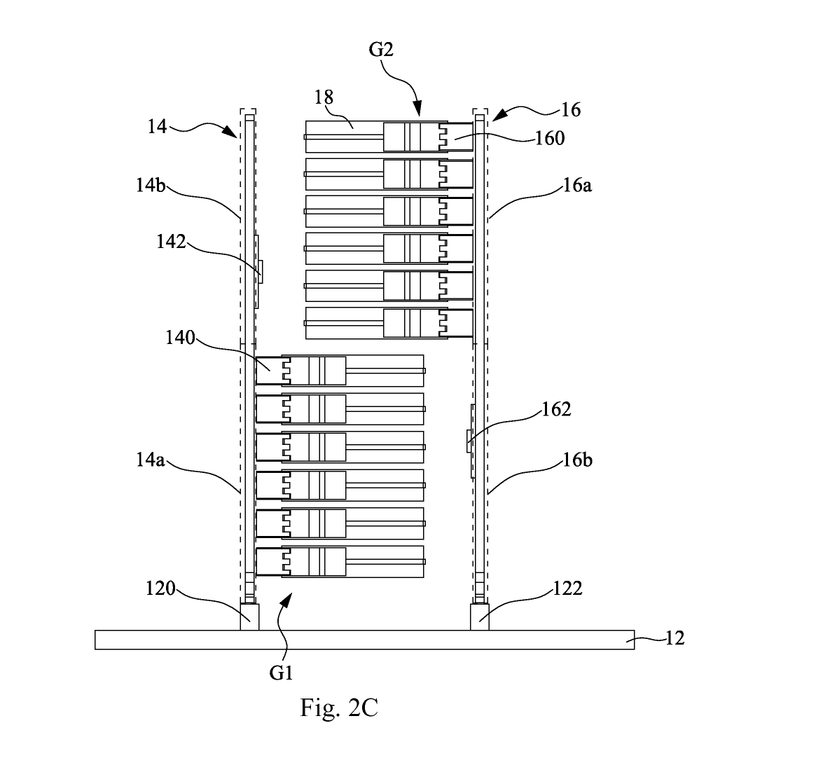

FIG. 2A is a perspective view illustrating a memory combination plugged into a motherboard 12 in the computer system 1 of FIG. 1 according to an embodiment of the invention. FIG. 2B is another perspective view illustrating the memory combination plugged into the motherboard 12 in FIG. 2A. It should be noted that, in order to present structures of a first riser board 14 and a second riser board 16 clearly, memory modules 18 are omitted in FIGS. 2A and 2B but are illustrated in FIG. 2C.

As shown in FIGS. 2A and 2B, in this embodiment, the motherboard 12 of the computer system 1 is disposed in the housing 10. The motherboard 12 at least includes a first riser slot 120 and a second riser slot 122 disposed side by side. That is, in this embodiment, the first riser slot 120 and the second rise slot 122 of the motherboard 12 are parallel and closely adjacent to each other. In addition, the motherboard 12 may include more than one group of the first riser slots 120 and the second riser slots 122 thereon. In actual applications, the group number of the first riser slots 120 and the second riser slots 122 included on the motherboard 12 can be flexibly increased or decreased according to the actual demand.

In this embodiment, the memory combination includes a first riser board 14 and a second riser board 16. The first riser board 14 is plugged into the first riser slot 120 of the motherboard 12 and includes a plurality of first memory sockets 140. The second riser board 16 is plugged into the second riser slot 122 of the motherboard 12 and includes a plurality of second memory sockets 160. Since the first riser slot 120 and the second riser slot 122 of the motherboard 12 are parallel to each other and both of the first riser board 14 and the second riser board 16 are plugged onto the motherboard 12 perpendicularly, the first riser board 14 and the second riser board 16 are also parallel to each other. The part of the first riser board 14 plugged into the first riser slot 120 has metal terminals (not shown) so as to electrically connect the first riser board 14 to the first riser slot 120. Similarly, the part of the second riser board 16 plugged into the second riser slot 122 has metal terminals (not shown) so as to electrically connect the second riser board 16 to the second riser slot 122.

Additionally, when the first riser board 14 and the second riser board 16 are plugged onto the motherboard 12, the first memory sockets 140 on the first riser board 14 face the second riser board 16 and the second memory sockets 160 on the second riser board 16 face the first riser board 14. In other words, in this embodiment, when the first riser board 14 and the second riser board 16 are plugged onto the motherboard 12, the first memory sockets 140 on the first riser board 14 and the second memory sockets 160 on the second riser board 16 are disposed in an opposite position. The first memory sockets 140 on the first riser board 14 and the second memory sockets 160 on the second riser board 16 are all available to plug in memory modules 18 (referring to FIG. 2C). For example, the memory modules 18 may be Dual In-line Memory Modules (DIMMs), although the invention is not limited to such. The parts of the memory modules 18 plugged into the first memory sockets 140 or the second memory sockets 160 have metal terminals (not shown) so as to electrically connect the memory modules 18 to the first memory sockets 140 or the second memory sockets 160.

It should be noted that, in order to place more memory modules 18 in the limited space of the computer system 1, the first memory sockets 140 on the first riser board 14 are unaligned with the second memory sockets 160 on the second riser board 16 in the invention. Through this arrangement manner, when all the first memory sockets 140 and the second memory sockets 160 are filled full of memory modules 18, the memory modules 18 between the first riser board 14 and the second riser board 16 are unaligned with each other and arranged more closely so as to use the space between the first riser board 14 and the second riser board 16 effectively.

FIG. 2C illustrates a side view of the memory combination and the motherboard 12 in FIG. 2A.

As shown in FIGS. 2A-2C, in this embodiment, the first riser board 14 further includes a first control chip 142. The first control chip 142 of the first riser board 14 is electrically connected to the first memory sockets 140 so as to control and process the data exchange between the memory modules 18 plugged into the first memory sockets 140 and the motherboard 12. The second riser board 16 further includes a second control chip 162. The second control chip 162 of the second riser board 16 is electrically connected to the second memory sockets 160 so as to control and process the data exchange between the memory modules 18 plugged into the second memory sockets 160 and the motherboard 12.

Furthermore, in this embodiment, the first memory sockets 140 on the first riser board 14 are closely arranged to form a first memory socket group G1. The first memory socket group G1 and the first control chip 142 are located in a first region 14a and a second region 14b on the first riser board 14 (as shown by dash lines in FIGS. 2A-2C), respectively. The second memory sockets 160 on the second riser board 16 are closely arranged to form a second memory socket group G2. The second memory socket group G2 and the second control chip 162 are located in a third region 16a and a fourth region 16b on the second riser board 16 (as shown by dash lines in FIGS. 2A-2C), respectively. The memory combination of this embodiment enables the first region 14a of the first riser board 14 to be aligned with the fourth region 16b of the second riser board 16 (i.e., the region of the first memory socket group G1 is aligned with the region of the second control chip 162) and enables the second region 14b of the first riser board 14 to be aligned with the third region 16a of the second riser board 16 (i.e., the region of the first control chip 142 is aligned with the region of the second memory socket group G2), so that the first memory socket group G1 is unaligned with the second memory socket group G2.

Accordingly, although the first memory sockets 140 cannot be disposed in the second region 14b on the first riser board 14 where the first control chip 142 is disposed, the memory modules 18 plugged into the second memory socket group G2 extend towards the first control chip 142 in the second region 14b. Therefore, the space on the first riser board 14 which is occupied by the first control chip 142 just can be used to place the memory modules 18 plugged into the second memory socket group G2 effectively. Similarly, although the second memory sockets 160 cannot be disposed in the fourth region 16b on the second riser board 16 where the second control chip 162 is disposed, the memory modules 18 plugged into the first memory socket group G1 extend towards the second control chip 162 in the fourth region 16b. Therefore, the space on the second riser board 16 which is occupied by the second control chip 162 just can be used to place the memory modules 18 plugged into the first memory socket group G1 effectively.

Additionally, in this embodiment, the arrangement direction of the first memory sockets 140 on the first riser board 14 is perpendicular to the motherboard 12 while the arrangement direction of the second memory sockets 160 on the second riser board 16 is also perpendicular to the motherboard 12 (as shown in FIGS. 2A-2C).

However, the arrangement direction of the first memory sockets 140 on the first riser board 14 and the arrangement direction of the second memory sockets 160 on the second riser board 16 are not limited to the direction parallel to the motherboard 12. In another embodiment, the arrangement direction of the first memory sockets 140 on the first riser board 14 may be optionally perpendicular or parallel to the motherboard 12 while the arrangement direction of the second memory sockets 160 on the second riser board 16 also may be optionally perpendicular or parallel to the motherboard 12.

In other words, as long as on the first riser board 14 the first memory socket group G1 is unaligned with the second memory socket group G2 and aligned with the second control chip 162 (i.e., the first region 14a being unaligned with the third region 16a and aligned with the fourth region 16b) and on the second riser board 16 the second memory socket group G2 is unaligned with the first memory socket group G1 and aligned with the first control chip 142 (i.e., the third region 16a being unaligned with the first region 14a and aligned with the second region 14b), the memory combination of the invention can use the space between the first riser board 14 and the second riser board 16 effectively.

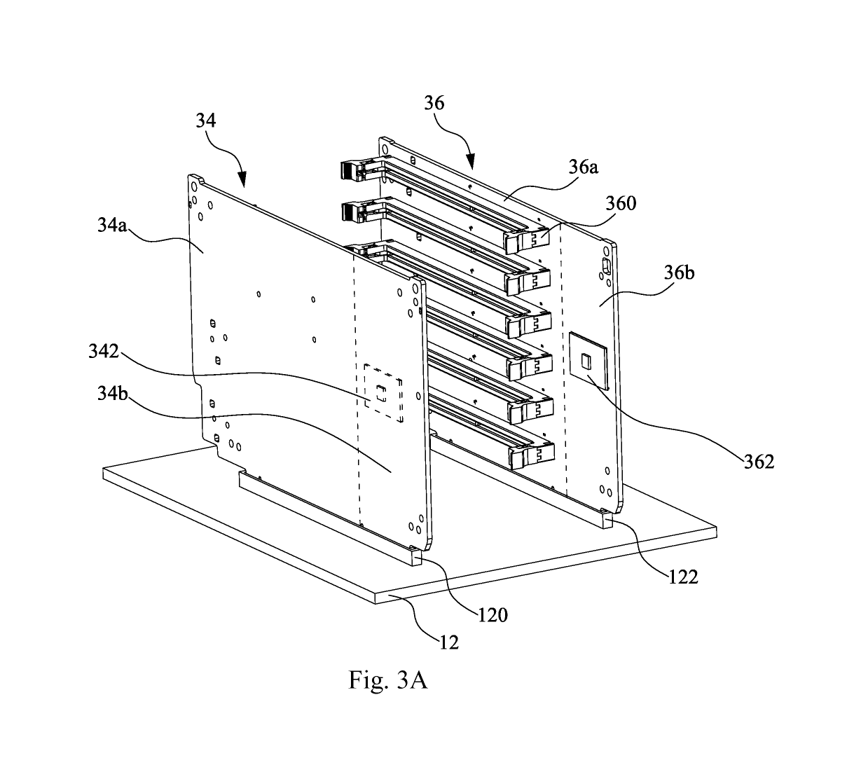

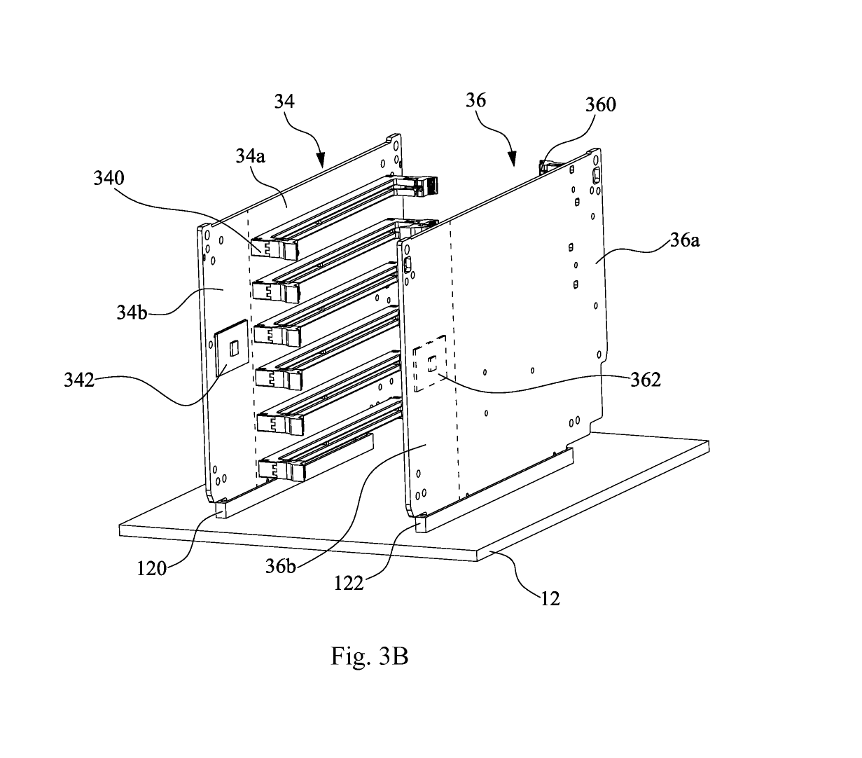

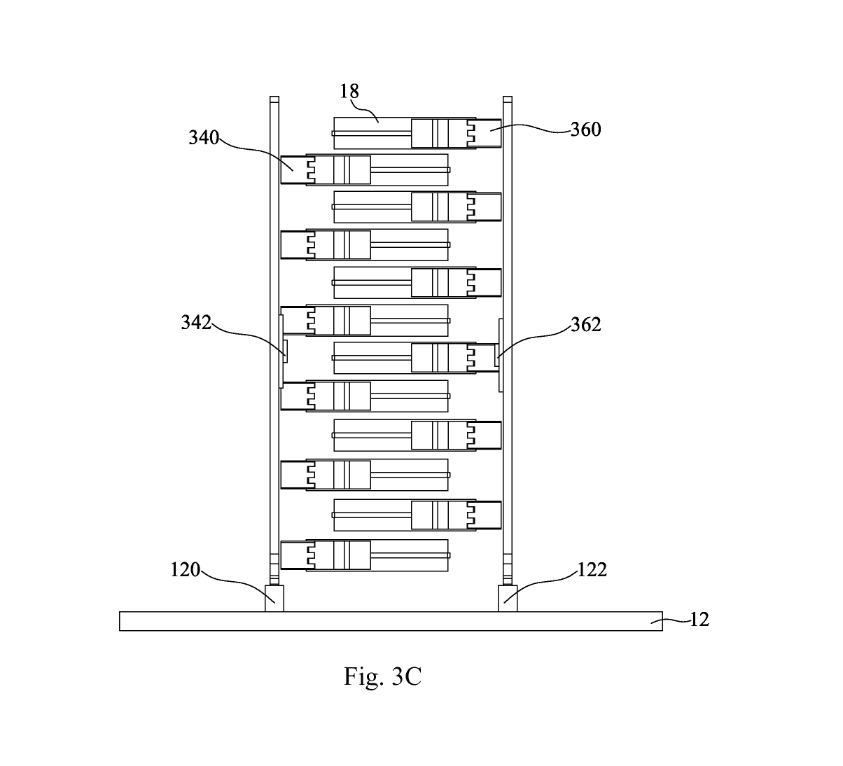

FIG. 3A is a perspective view illustrating a memory combination plugged into the motherboard 12 in the computer system 1 of FIG. 1 according to another embodiment of the invention. FIG. 3B is another perspective view illustrating the memory combination plugged into the motherboard 12 in FIG. 3A. FIG. 3C is a side view illustrating the memory combination and the motherboard 12 in FIG. 3A. It should be noted that, in order to present structures of a first riser board 34 and a second riser board 36 clearly, the memory modules 18 are omitted in FIGS. 3A and 3B but are illustrated in FIG. 3C.

As shown in FIGS. 3A-3C, in this embodiment, the motherboard 12 of the computer system 1, the first riser slot 120 and the second riser slot 122 on the motherboard 12 and the memory modules 18 available to the computer system 1 are all the same as those in the embodiments shown in FIGS. 2A-2C. Accordingly, the above-mentioned related description can be referred to and will not be discussed anymore herein.

As shown in FIGS. 3A and 3B, in this embodiment, first memory sockets 340 and a first control chip 342 are located in a first region 34a and a second region 34b on the first riser board 34 (as shown by dash lines in FIGS. 3A and 3B) respectively. Second memory sockets 360 and a second control chip 362 are located in a third region 36a and a fourth region 36b on the second riser board 36 (as shown by dash lines in FIGS. 3A and 3B) respectively.

It should be noted that, a difference between the memory combination of this embodiment and the memory combination of the embodiments shown in FIGS. 2A-2C is that the memory combination of this embodiment enables the first region 34a of the first riser board 34 to be aligned with the third region 36a of the second riser board 36 (i.e., the region of the first riser slot 120 being aligned with the region of the second riser slot 122) and enables the second region 34b of the first riser board 34 to be aligned with the fourth region 36b of the second riser board 36 (i.e., the region of the first control chip 342 being aligned with the region of the second control chip 362).

Additionally, it should be noted that, another difference between the memory combination of this embodiment and the memory combination of the embodiments shown in FIGS. 2A-2C is that in this embodiment the first memory sockets 340 on the first riser board 34 and the second memory sockets 360 on the second riser board 36 are unaligned with each other by an alternated and staggered arrangement manner rather than in the form of groups.

Furthermore, a gap between any two adjacent ones of the first memory sockets 340 on the first riser board 34 is aligned with one of the second memory sockets 360 on the second riser board 36. A gap between any two adjacent ones of the second memory sockets 360 on the second riser board 36 is aligned with one of the first memory sockets 340 on the first riser board 34. More particularly, in this embodiment, the direction of each first memory socket 340 is the same as the direction of each second memory socket 360. Therefore, when all the first memory sockets 340 and the second memory sockets 360 are filled full of memory modules 18, the memory modules 18 between the first riser board 34 and the second riser board 36 do not interfere with each other.

Through the above-mentioned arrangement manner, when all the first memory sockets 340 and the second memory sockets 360 are filled full of memory modules 18, the memory modules 18 between the first riser board 34 and the second riser board 36 may be presented with an interdigitated profile, in which the memory modules 18 are overlapped and staggered to each other, so that the memory modules 18 can be arranged more closely, to use the space between the first riser board 34 and the second riser board 36 effectively.

Additionally, in this embodiment, the arrangement direction of the first memory sockets 340 on the first riser board 34 is perpendicular to the motherboard 12 while the arrangement direction of the second memory sockets 360 on the second riser board 36 is also perpendicular to the motherboard 12 (as shown in FIGS. 3A-2C). However, the invention is not limited to such and arrangement. In another embodiment, the arrangement direction of the first memory sockets 340 on the first riser board 34 is parallel to the motherboard 12 while the arrangement direction of the second memory sockets 360 on the second riser board 36 is also parallel to the motherboard 12.

From the above detailed description of the specific embodiments of the invention, it can be seen obviously that an essential feature of the memory combination and computer system of the invention is that when the two riser boards are plugged onto the motherboard, the memory sockets on the two riser boards are disposed in an opposite direction and are unaligned with each other. Accordingly, when the all the memory sockets are filled full of memory modules, the memory modules between the two riser boards are unaligned with each other and arranged more closely so as to use the space between the two riser boards effectively. Additionally, another essential feature of the memory combination and computer system of the invention is that the memory sockets on any one of the two riser boards are unaligned with the memory sockets on the other riser board in the form of groups and are aligned with the position of the control chip on the other riser board. Accordingly, the space between the two riser boards corresponding to two control chips is not unused so as to improve the space utilization of the memory combination more effectively.

Although the invention has been disclosed with reference to the above embodiments, these embodiments are not intended to limit the invention. Those of skills in the art can make various variations and modifications without departing from the spirit and scope of the invention. Therefore, the scope of the invention should be defined by the appended claims.

What is claimed is:

1. A memory combination, applied in a computer system, wherein the computer system comprises a motherboard, the motherboard comprises a first riser slot and a second riser slot disposed side by side, and the memory combination comprises:
a first riser board plugged into the first riser slot and comprising a plurality of first memory sockets; and
a second riser board plugged into the second riser slot and comprising a plurality of second memory sockets, wherein the first memory sockets face the second riser board and the second memory sockets face the first riser board,
wherein the first memory sockets are unaligned with the second memory sockets.

2. The memory combination of claim 1, wherein the first memory sockets are arranged closely to form a first memory socket group, the second memory sockets are arranged closely to form a second memory socket group, and the first memory socket group is unaligned with the second memory socket group.

3. The memory combination of claim 2, wherein the first riser board further comprises a first control chip electrically connected to the first memory sockets, the first memory sockets and the first control chip are located on a first region and a second region of the first riser board respectively, the second riser board further comprises a second control chip electrically connected to the second memory sockets, the second memory sockets and the second control chip are located on a third region and a fourth region of the second riser board respectively, the first region is aligned with the fourth region, and the second region is aligned with the third region.

4. The memory combination of claim 1, wherein the first memory sockets and the second memory sockets are unaligned with each other in an alternated and staggered arrangement manner.

5. The memory combination of claim 4, wherein a gap between any two adjacent ones of the first memory sockets is aligned with one of the second memory sockets, and a gap between any two adjacent ones of the second memory sockets is aligned with one of the first memory sockets.

6. A computer system comprising:
a motherboard comprising a first riser slot and a second riser slot disposed side by side;
a first riser board plugged into the first riser slot and comprising a plurality of first memory sockets; and
a second riser board plugged into the second riser slot and comprising a plurality of second memory sockets, wherein the first memory sockets face the second riser board and the second memory sockets face the first riser board,
wherein the first memory sockets are unaligned with the second memory sockets.

7. The computer system of claim 6, wherein the first memory sockets are arranged closely to form a first memory socket group, the second memory sockets are arranged closely to form a second memory socket group, and the first memory socket group is unaligned with the second memory socket group.

8. The computer system of claim 7, wherein the first riser board further comprises a first control chip electrically connected to the first memory sockets, the first memory sockets and the first control chip are located on a first region and a second region of the first riser board respectively, the second riser board further comprises a second control chip electrically connected to the second memory sockets, the second memory sockets and the second control chip are located on a third region and a fourth region of the second riser board respectively, the first region is aligned with the fourth region and the second region is aligned with the third region.

9. The computer system of claim 6, wherein the first memory sockets and the second memory sockets are unaligned with each other in an alternated and staggered arrangement manner.

10. The computer system of claim 9, wherein a gap between any two adjacent ones of the first memory sockets is aligned with one of the second memory sockets, and a gap between any two adjacent ones of the second memory sockets is aligned with one of the first memory sockets.
